(19) United States
(12) Patent Application Publication
(10) Pub. No.: US 2004/0025399 A1
(43) Pub. Date: Feb. 12, 2004

(54) Decoy moving apparatus and methods

(75) Inventors: Stephen N. Donnigan, Knoxville, TN (US); Jeffrey S. Lewis, Thornton, CO (US); Lance E. Smith, Fort Colllins, CO (US)

Correspondence Address: SANTANGELO LAW OFFICES, P.C., 125 SOUTH HOWES, THIRD FLOOR, FORT COLLINS, CO, 80521, US

(73) Assignee: Dynamic Decoy Technologies, LLC, Fort Collins, CO

(21) Appl. No.: 10/621,241

(22) Filed: Jul. 15, 2003

Related U.S. Application Data
(60) Provisional application No. 60/395,930, filed on Jul. 15, 2002.

(51) Int. Cl. A01M 31/06

(52) U.S. Cl. 43/2

(57) ABSTRACT

An animal decoy moving apparatus that, in at least one embodiment, comprises a base element; a turntable responsive to the base element and configured to support an animal decoy that is commercially available separately from the animal decoy moving apparatus; a wind independent turntable motion provision element to which the turntable is responsive; and an animal decoy attachment element usable to attach the separately commercially available animal decoy to the turntable, is disclosed. An animal decoy moving apparatus of at least one embodiment of the invention may be usable to impart motion to at least three different types of conventional, stationary animal decoys (e.g., shell; free-standing, full body; and post supported), at different times, without requiring substantive modification of any of these decoys.

### I. CROSS-REFERENCES TO RELATED APPLICATIONS

This application claims the benefit of and priority to U.S. Provisional Application 60/395,930, filed Jul. 15, 2002, entitled “Moving Decoy Base”, hereby incorporated by reference.

### II. BACKGROUND OF THE INVENTION

Generally, this invention relates to a system for moving a decoy used to attract animals. Specifically, the invention focuses on apparatus and methods for moving a commercially available animal decoy so as to impart a more life-like appearance to the decoy and thereby enhance the effect of the decoy to attract an animal(s) of interest.

The desire to attract animals has been known for some time, particularly among those who hunt. Decoys can be of help in attracting an animal of interest from an “out-of-range”location to an “in-range” location (perhaps near a hunter's pit or blind) through exploiting the animal of interest's sense of attraction to a certain type of animal mimicked by the decoy, thereby effecting a relocation of the animal of interest to the vicinity of the decoy (typically, the “in-range” location). Whether this attraction and subsequent relocation is caused by instilling a sense of security and safety in the animal of interest in the “in-range” location (e.g., a flock of Canada geese decoys located at the edge of a pond), or by appealing to the animal of interest's mating or hunting instincts (e.g., a hen to attract a tom turkey, or a chicken decoy to attract a predator coyote) or, for that matter, any other visually triggered attraction mechanism, the relocation of the animal of interest from the out-of-range location to the in-range location significantly increases a hunter's chance of killing the animal of interest, whether that kill be achieved by gunshot, bow and arrow, trapping, or other means. The intended relocation might also be sought for reasons other than hunting, such as animal watching or study (observation), and photography.

The traditional use of conventional decoys, however, has not been without its problems. Most notable of these problems may be that attributable to the stationary nature of conventional decoys. As any animal mimicked by a decoy would typically move when in the “in-range” location and at the times that decoy is there-positioned, a stationary decoy may not display as life-like an appearance as may be necessary to attract the animal of interest, and thus may compromise the decoy's effectiveness in “bringing down game.” In response, several decoy moving products able to mimic feeding, mating, typical response, or other motions, whether controlled or not, have been introduced.

Although perhaps more effective in attracting an animal of interest than their stationary predecessors, the conventional decoy moving products are also not without significant disadvantages. Most significant among them is their compatibility with only certain types of decoys, whether because (a) that conventional system product is usable to move only those decoys that are specially designed and manufactured (through “factory” customization, e.g.) to work with the decoy moving part of that conventional system; (b) that conventional system product is usable to move only a certain type of the conventional stationary decoys (such as commercially available decoys of the shell or hollow-body type); or (c) that, with regard to at least one type of conventional stationary decoy (e.g., free-standing, full-body) the conventional system product is usable to move only a decoy of this type after it has been substantively modified from its store-bought configuration.

This lack of complete compatibility (or phrased differently, this limited compatibility) has direct and significant negative ramifications for the user of that conventional decoy moving system, the specific nature of which depends on the reason for the limited compatibility. Specifically, if the limited compatibility is attributable to (a) above (nominally, the “factory-specialized decoy requirement”); (b) above (nominally, the “specific conventional stationary decoy design requirement”); and/or (c) above (nominally, the “conventional stationary decoy modification requirement”), a user of the conventional systems observes different consequences as follows.

If the limited compatibility is attributable to (a) above (the “factory specialized decoy requirement”), a hunter, e.g. (or other user) who desires decoy moving capability would need to outlay the expense of buying at least one of these specialized decoys, regardless if that hunter already owns conventional stationary animal decoys. Often, as multi-decoy arrangements are typically more effective in attracting animals of interest, a hunter desiring a moving decoy arrangement would need to purchase several of the specialized moving decoys, an often-times prohibitive expense. Indeed, the conventional, stationary-type decoy(s) that a hunter might own before deciding to purchase any of the conventional moving decoy products that require a factory-specialized decoy would be incompatible with these conventional moving decoy products, and thus, essentially useless as part of the conventional decoy moving product.

Further, a hunter, e.g., using a “factory specialized decoy requirement” limited system (e.g., as disclosed by the “Feather Flex Rigor Rabbit Motion Decoy” sold by Cabela's) who would like to have stationary decoy arrangement and moving decoy arrangement capability at different times would need to purchase as many stationary decoys which that hunter would like in his or her stationary arrangement in addition to as many of the specialized movable decoys that hunter would like in his or her moving arrangement that are required by conventional decoy moving products having the factory specialized decoy requirement. At least one embodiment of the instant invention eliminates the “factory specialized decoy requirement”.

If the limited compatibility is instead (or additionally) attributable to (b) above (the “specific conventional stationary decoy design requirement”), a user of such conventional system observes different consequences. Simply, such a user is limited to the type of stationary decoy with which the decoy moving system is uniquely compatible. Other types of decoys are simply not within the design parameters of the system and thus, simply are not usable with such system. For example, in the case of U.S. Pat. No. 6,481,147 to Lindaman and U.S. Pat. No. 5,036,614 to Jacson, a user is limited to a shell decoy; in the case of Cabela's Goose Walker Swivel, a user is limited to a self-standing full-body decoy; in the case of U.S. Pat. No. 6,442,884 to Sceery, a user is limited to a full-body decoy; in the case of U.S. Pat. No. 5,233,780 to Overholt, a post-supported turkey decoy; in the case of U.S. Pat. No. 5,459,958 to Reinke, a shell decoy. Thus, a hunter, e.g., who owns only that type of conventional stationary decoy with which a conventional decoy moving system having the “specific conventional stationary decoy design requirement” is incompatible (e.g., a full body turkey decoy) must purchase those conventional decoy types (e.g. a shell turkey decoy) simply because the system is compatible with only a certain type of decoy. At least one embodiment of the instant invention eliminates the “specific conventional stationary decoy design requirement”.

If the limited compatibility is instead (or additionally) attributable to (c) above (the “conventional stationary decoy modification requirement”), the limited compatibility manifests itself as that product's incompatibility with at least one type of conventional stationary decoy (e.g., free-standing, full-body) substantively unmodified from the decoy's intended configuration, which may be as-purchased or as assembled after purchase, e.g. For example, U.S. Pat. No. 6,212,816 to Babbitt et al, is usable with free-standing, full body decoys only after the foot and leg assembly that is an important part of the decoy is eliminated from the decoy to provide a “plug-in” site for the decoy mount. The elimination of a part such as the foot and leg assembly that plays an important contributory role in the decoy's life-like animal appearance would expectedly compromise the decoy's attractive effect, at least in certain situations. Thus, substantive modifications such as required by Babbitt's design present a problem to hunters and others desiring uncompromised animal attraction. At least one embodiment of the instant invention eliminates the “conventional stationary decoy modification requirement” and is usable to move each of at least three different types of animal decoys (e.g., separately commercially available animal decoys) at different times without requiring substantive modification (or perhaps even no modification whatsoever) of the decoy. Different types refers to e.g., shell decoy vs. post-supported decoy vs. full-body decoy (including free-standing, full body decoy), as but a few examples.

It is important to the above-mentioned elimination of disadvantages may refer to but one of several differences between the inventive technology and that of the prior art. For instance, at least one embodiment of the instant invention is different from the Babbitt et al disclosure (U.S. Pat. No. 6,212,816) not only in that this embodiment(s) does not require modification of a conventional stationary decoy, but also in that this embodiment(s) includes a turntable and at least one decoy attachment element. Indeed, it is this feature that plays a key role in the provision of at least one of the above-mentioned advantages of the technology disclosed herein.

As but one other example, it is of note that not only is at least one embodiment of the instant inventive technology different from Cabela's Goose Walker Swivel in that this Cabela's product is limited to moving a self-standing full-body decoy because of its specific conventional stationary decoy design requirement, but also, the instant inventive technology includes a wind independent turntable motion provision element not found in Cabela's product. Such “wind independence”, either alone or in combination with other features, relates to another advantage of at least one embodiment of the instant inventive technology—the provision of controlled and reliable animal movement mimicking operation.

### III. SUMMARY OF THE INVENTION

The present invention includes a variety of aspects which may be selected in different combinations based upon the particular application or needs to be addressed. In one basic form, the invention discloses an animal decoy moving apparatus and related methods that are usable to controllably move a variety of commercially available animal decoys substantively unmodified from the decoy's intended configuration. It may be the provision of turntable and a decoy attachment element (which includes, inter alia, any of several decoy adapters to facilitate attachment of a variety of decoy types) that makes the instant invention's decoy moving apparatus compatible with either (a) more commercially available decoy types than some conventional, “limited compatibility” decoy movers; or (b) commercially available animal decoys substantively unmodified from the decoy's intended configuration with which other conventional, “limited compatibility” decoy movers are incompatible. Such an enhanced compatibility may result in considerable monetary savings for a hunter, animal watcher, or animal photographer who, e.g., already owns conventional stationary decoy(s) of different types and wants to use a decoy moving apparatus to controllably move these decoys in a configuration that is substantively unmodified from that intended by the stationary decoy's manufacturer or designer.

It is a goal of at least one embodiment of the invention to provide a decoy moving apparatus and related method that exhibits a compatibility with commercially available stationary decoys (e.g. conventional stationary decoys) that is enhanced relative to conventional decoy moving apparatus and systems.

It is a goal of at least one embodiment of the invention to provide a decoy moving apparatus that is usable with the predominant decoy types (e.g., shell, full-body, post-supported) at different times, without requiring modification, including substantive modification, of the decoy. Substantive modification includes removing a foot assembly that is part of the decoy, or generally, changing the decoy in (a) a manner that could feasibly alter the decoy's effectiveness in attracting an animal of interest; and (b) a manner that involves more than de minimus effort. Thus, substantive modification excludes merely drilling a small hole in, e.g., a shell decoy (such would, however, be a modification).

It is a goal of at least one embodiment of the invention to provide a decoy moving apparatus and related method that allows for considerable savings in conventional stationary decoy costs in certain situations.

It is a goal of at least one embodiment of the invention to provide a decoy moving apparatus and related method that allows for considerable savings in cost outlay by a user intent on using (at different times) the decoy moving, system for certain, different decoy types (such as at least three different decoy types), where the decoys of each type are substantively unmodified from the decoy's intended configuration when attached to the decoy mover.

It is a goal of at least one embodiment of the invention to provide a decoy moving apparatus and related method that is usable to impart controlled motion to a commercially available stationary animal decoy (e.g., a conventional stationary animal decoy) using a turntable and an animal decoy attachment element, and realize the advantages afforded thereby.

Naturally, further objects of the invention are disclosed throughout other areas of the specification and claims.

### IV. BRIEF DESCRIPTION OF THE DRAWINGS

FIG. 1 shows a turntable, base element and decoy attachment element of at least one embodiment of the inventive apparatus.

FIG. 2 shows a turntable, base element and decoy attachment element of at least one embodiment of the inventive apparatus.

FIG. 3 shows the turntable motion provision element positioned under the turntable surface of at least one embodiment of the inventive apparatus.

FIG. 4 shows a type of full body animal decoy adapter found in at least one embodiment of the inventive apparatus.

FIG. 5 shows a post supported decoy adaptor used in at least one embodiment of the inventive apparatus.

FIG. 6 shows a shell animal decoy adapter used in at least one embodiment of the inventive apparatus.

FIG. 7 shows a solid foot decoy adapter used in at least one embodiment of the inventive apparatus.

FIG. 8 shows the underside of a solid foot decoy adapter used in at least one embodiment of the inventive apparatus.

FIG. 9 shows the foot assembly of a free-standing, fully body decoy attached to at least one embodiment of the inventive apparatus.

FIG. 10 shows an underside of a conventional and commercially available shell decoy (prior art). FIG. 11 shows a conventional and commercially available, free-standing, full body decoy (prior art).

FIG. 12 shows a conventional and commercially available, shell decoy (prior art).

FIG. 13. shows electronic componentry of at least one embodiment of the inventive apparatus.

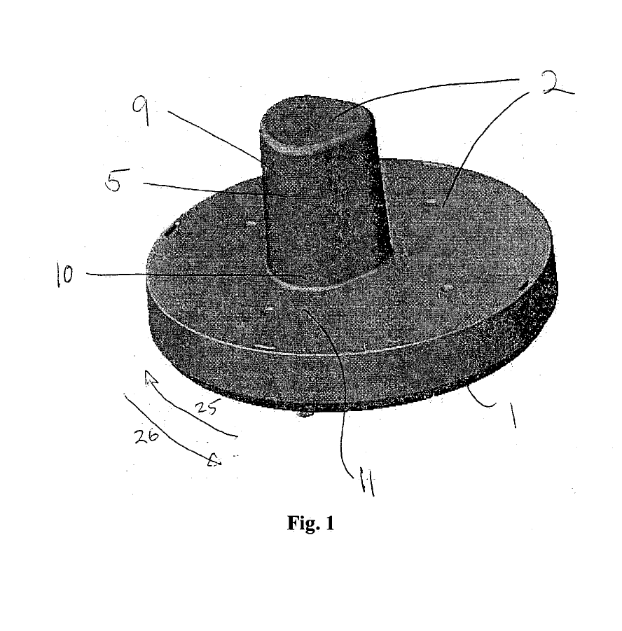

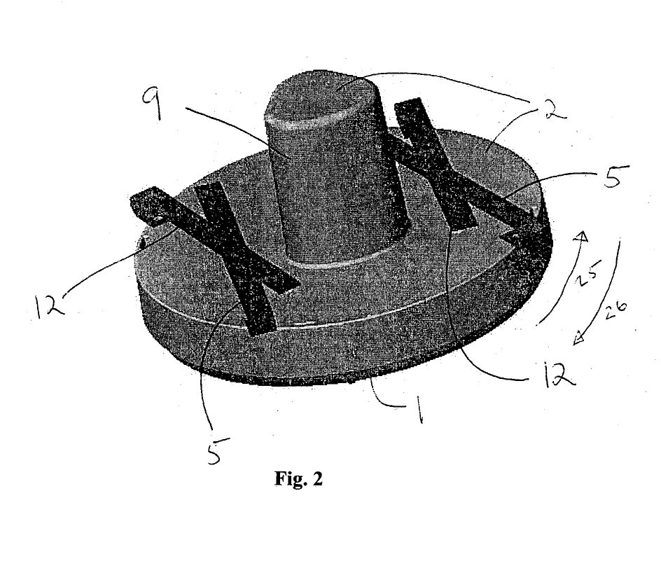

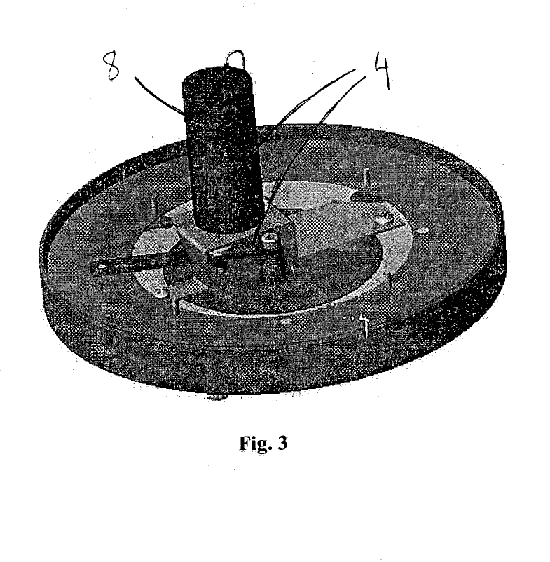

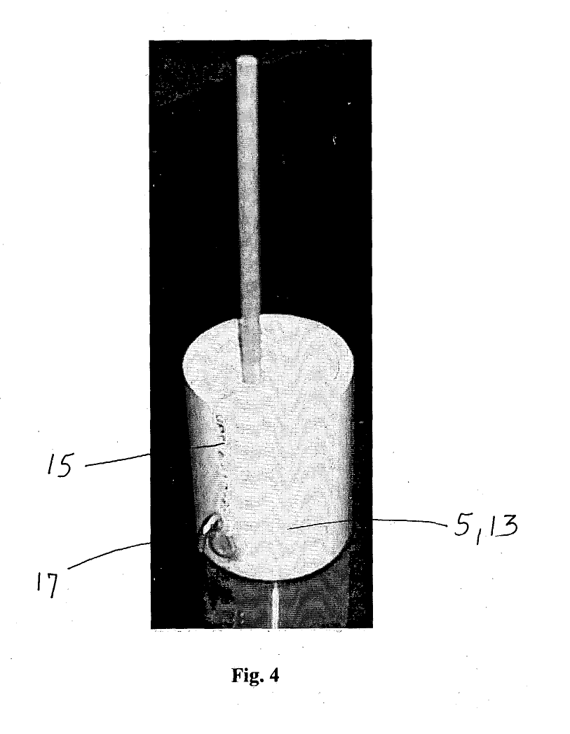

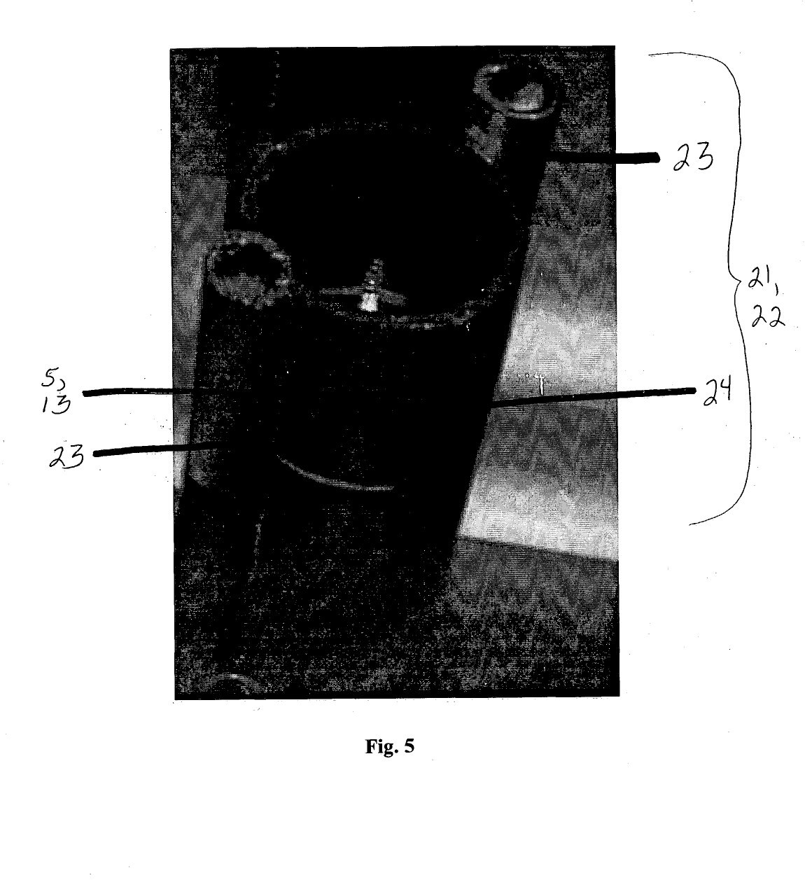

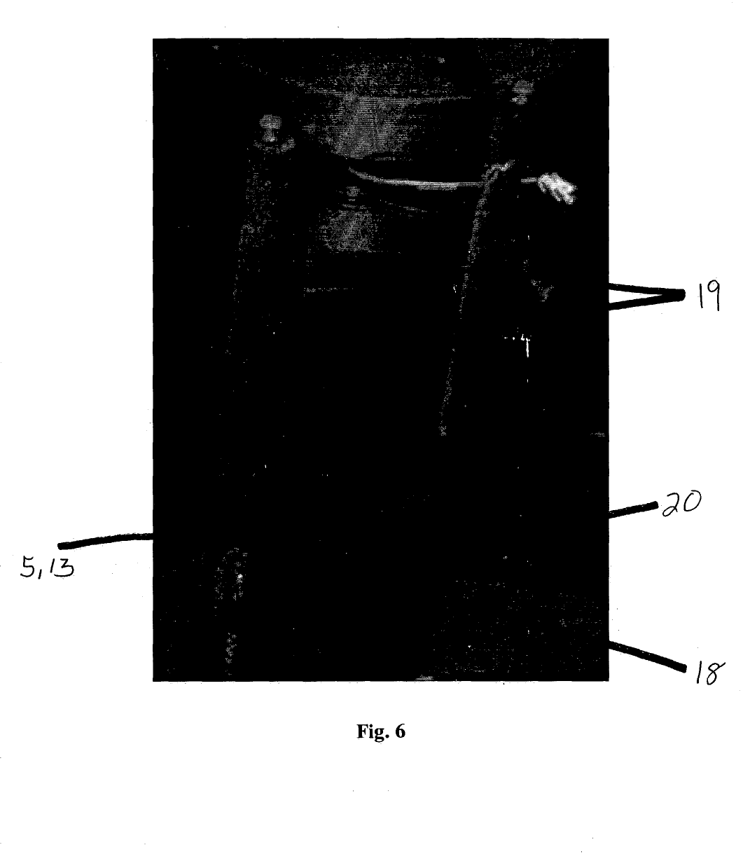

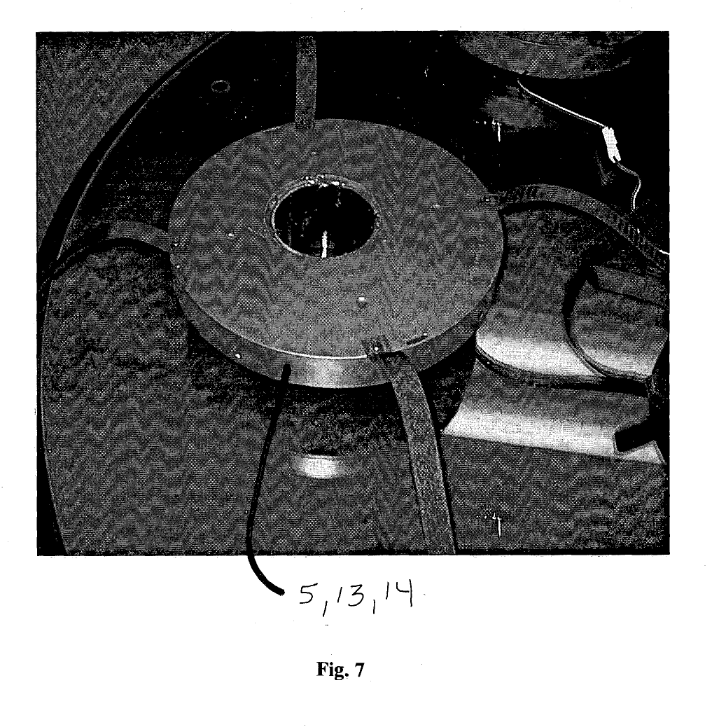

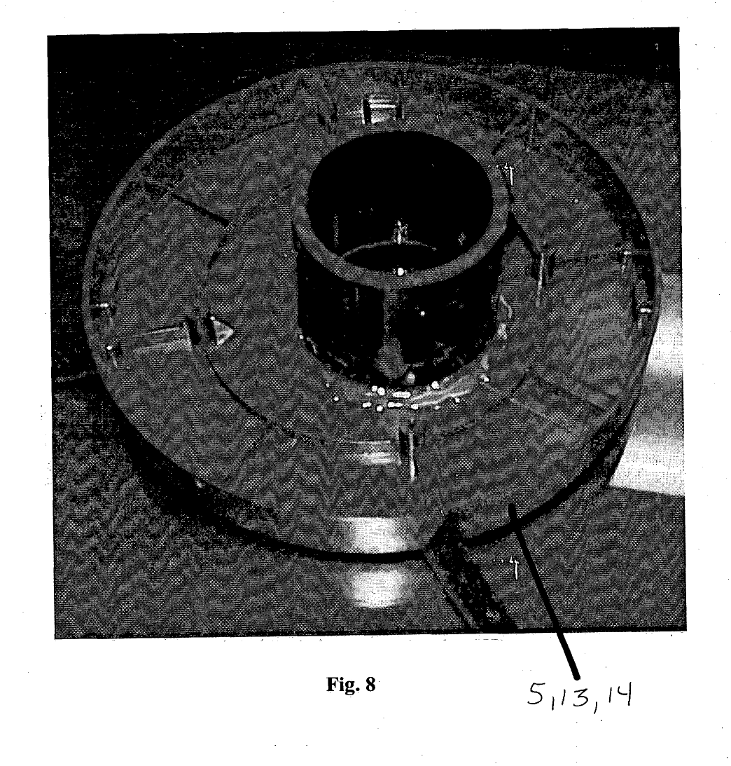

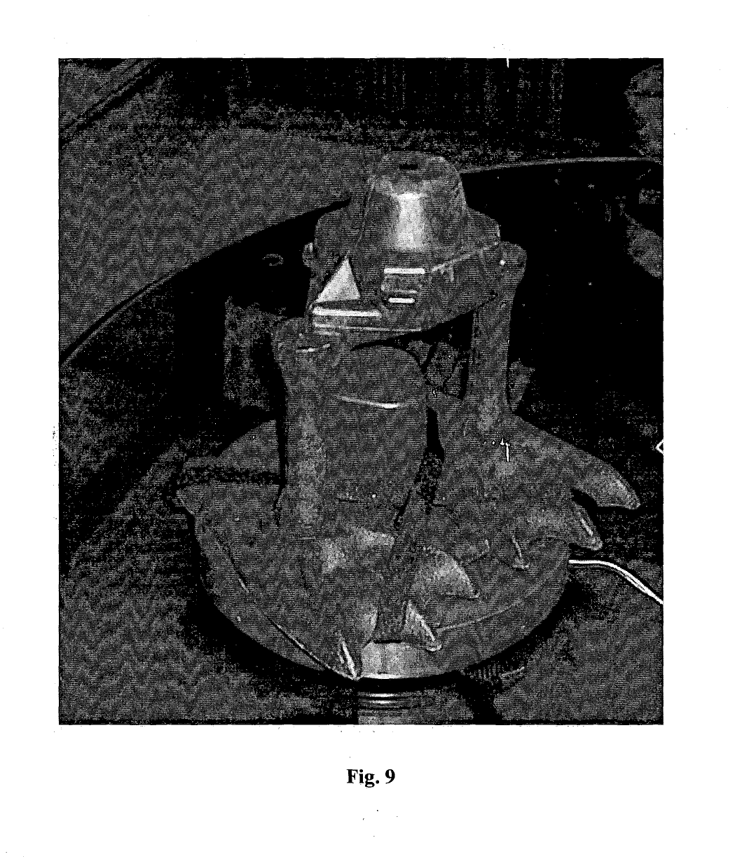

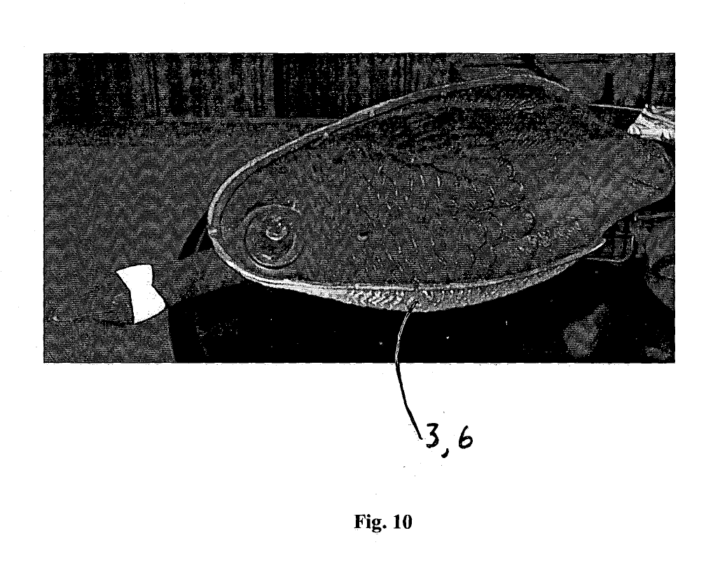

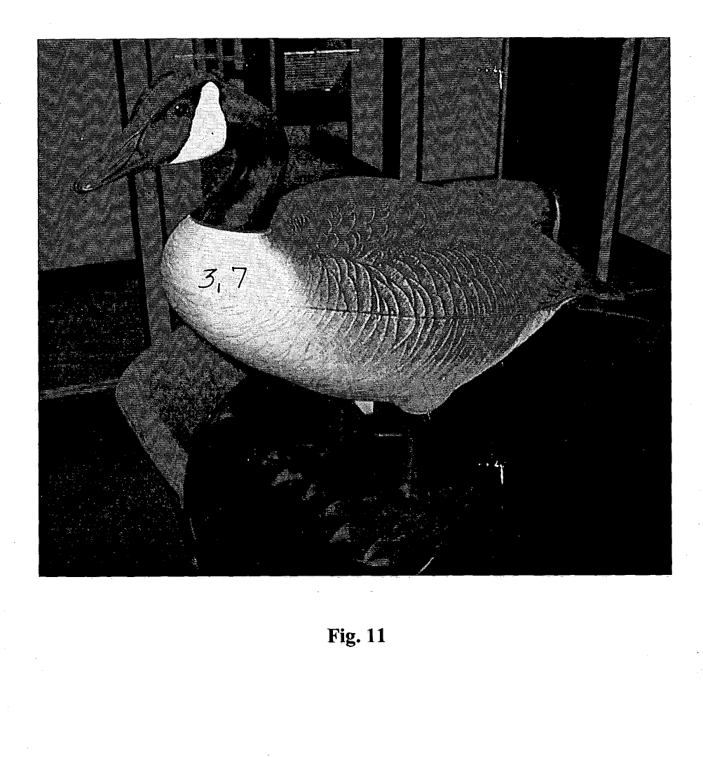

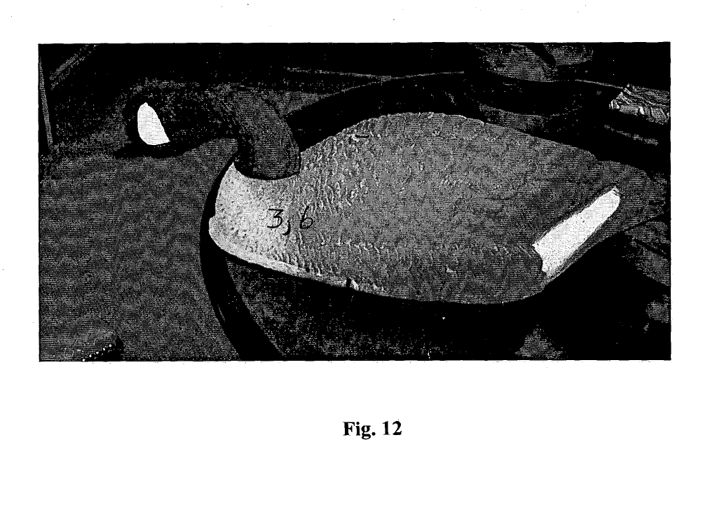

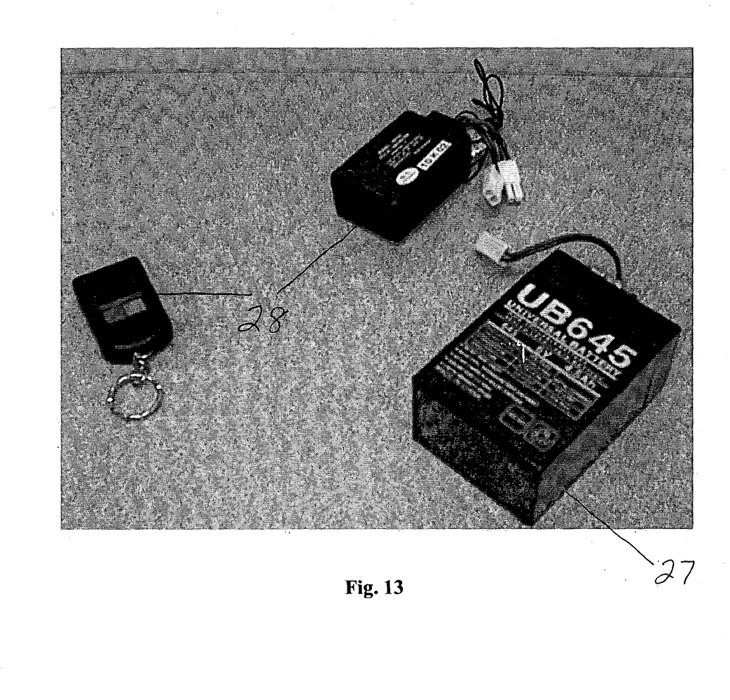

### V. DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should further be understood to support and encompass descriptions and claims of all the various embodiments, systems, techniques, methods, devices, and applications with any number of the disclosed elements, with each element alone, and also with any and all various permutations and combinations of all elements in this or any subsequent application.

At least one embodiment of the invention is an animal decoy moving apparatus that comprises a base element (1); a turntable (2) responsive to the base element and configured to support an animal decoy (3) that is commercially available separately from the animal decoy moving apparatus; a wind independent turntable motion provision element (4) to which the turntable is responsive; and an animal decoy attachment element (5) usable to attach the separately commercially available animal decoy to the turntable. The animal decoy moving apparatus may be usable to impart motion to decoys of different kinds of animals at different times; it may also or instead be usable to impart motion to both shell animal decoys (6) and full-body animal decoys (7) at different times. It is important to understand that the term “turntable” includes revolvable or rotatable platforms or surfaces that are not only round, circular, or disc shaped in plan view, but also a multitude of other shapes (e.g., square and rectangular). The turntable need not be flat (indeed, in at least one embodiment of the instant invention, the turntable has a column projecting vertically from a lower portion of the turntable).

In at least one embodiment of the invention, the separately commercially available animal decoy may a duck decoy, goose decoy, turkey decoy, rabbit decoy, deer decoy, or elk decoy, as but a few examples. The decoy may also be characterized as a waterfowl decoy (including goose decoy and duck decoys, as but two examples), or gamebird decoy (including turkey, goose, duck, quail, e.g.), a deer decoy, or an elk decoy. The apparatus may be intended for attracting predators, in which case the animal decoy may be a rabbit decoy, a bird decoy, a fawn decoy, or a tuft of fur (a type of furred animal decoy), as but a few examples. The term furred animal decoy is as opposed to feathered animal decoys and includes a tuft of fur or a decoy that is more similar in appearance to an actual furred animal. Predators that may be targeted for attraction by the decoy as moved by animal decoy moving apparatus include coyotes, crows, bears, lions, e.g. Indeed, an animal decoy moving apparatus that is usable to move a decoy intended to attract (or perhaps even repel!) any kind, type, species or genus of animal for whatever reason (of course, hunting among them) is contemplated by the inventors. At least one embodiment of the invention does not comprise the separately commercially available animal decoy.

In at least one embodiment, the animal decoy moving apparatus is electrical. In a preferred embodiment, the turntable is rotationally responsive to the wind independent turntable motion provision element in that, e.g., the wind independent turntable motion provision element may cause the turntable to rotate during apparatus operation (the term rotate includes all ranges of rotation, including less than full 360 degree rotation).

The wind independent turntable motion provision element may be electrical and may comprise a motor (8) that is established substantially in a column (9) that forms part of the turntable and whose base (10) is attached at a lower portion (11) of the turntable (such as substantially at a centroid of the lower portion of the turntable). In at least one embodiment, the turntable is substantially disc shaped. The turntable is configured to support an animal decoy even where the support is indirect (e.g., where the turntable is not directly in contact with the animal decoy).

The animal decoy attachment element comprises at least one decoy securing strap (12), such as a Velcro® strap, in at least one embodiment of the invention. The term element may refer to one or more part or structure; as but a few examples, the animal decoy attachment element may include a combined Velcro® strap(s) and a column (or either alone) and/or a magnetic system. It may comprise an animal decoy attachment adapter (13) that facilitates attachment of certain types of decoys to the decoy moving apparatus (thus enabling the impartation of motion from the apparatus to the decoy itself). By attach is merely meant that the impartation of some type of movement of the turntable to the decoy is enabled; preferably, the attachment is releasable. Attachment element includes (inter alia, of course) merely something that a decoy, e.g., a shell decoy or a decoy that does not have a solid foot, can slip over.

For certain types of animal decoys such as those having a solid foot (e.g., the Flambeau decoy), the animal decoy attachment adapter may be a solid foot decoy adapter (14) and may be usable to establish a flat upper surface on which the “solid footed” animal decoy may stand. Such a flat surface may be particularly in need where a column (in which an electric motor may reside) is established as part of the turntable. The solid foot decoy adapter, in at least one embodiment, may further comprise a Velcro® strap. Of course, the solid foot decoy adapter may be usable to attach other types of decoys where appropriate.

In at least one embodiment of the invention, the animal decoy attachment adapter is at least one support stake, full body animal decoy adapter (15) usable with a full body animal decoy having at least one support stake. The at least one support stake, full body animal decoy adapter may comprise a stake support element responsive to the turntable. The stake support element may comprise a column surrounding section, especially in the embodiment where the turntable includes a column. The invention may be deemed to include a decoy stake (16) supported by the stake support element and/or an elastic cord attachment element (17) to which the stake support element is responsive. Such elastic cord attachment elment may enable a desired superimposition of a biased, wind-driven rotation “on top of” wind-independent rotation. Such “layered” motion is deemed controlled, although where the only motion is wind-driven, such motion is deemed uncontrolled (even where there may be a bias element such as an elastic cord that, to some extent, centers the unpredictable motion.

In at least one embodiment of the invention, the animal decoy attachment adapter is a shell animal decoy adapter (18), which itself may comprise at least one decoy post (19) responsive to the turntable and configured for attachment inside of a shell animal decoy. The shell animal decoy adapter may comprise a decoy post support element (20). Particularly where there is a column as part of the turntable, the decoy post support element may comprise a column surrounding section, which itself may have a larger lower radius than upper radius for tight fit of the column surrounding section (and the decoy post support element that it may be a part of) around the column.

The animal decoy attachment adapter may be a post supported decoy (e.g., a turkey decoy) adapter (21), which may comprise a turntable motion impartation element (22) that is responsive to the turntable and that is usable to impart motion of the turntable to a post supported decoy. The turntable motion impartation element may comprise at least one post supported decoy post reception element (23), which may be a post supported decoy post retention element. The at least one post supported decoy post reception element may be two post supported decoy post reception elements. Particularly where the turntable comprises a column, the turntable motion impartation element may further comprise a column surrounding section (24) to which the at least one post supported decoy post reception element is responsive. The term post supported decoy is intended to include any decoy that is supportable by a post, and includes at least some types of turkey decoys, at least some types of panel decoys, and at least some types of silhouette decoys, to name a few.

Although in a preferred embodiment the animal decoy moving apparatus is intended to move a decoy about a vertical axis, at least one embodiment of the invention involves situating the apparatus so as to move only part of an animal (e.g., an animal head) about an axis which may, be non-vertical. Such would be the case where the apparatus were established within the neck of a deer or elk (e.g., at the base of its head) so as to impart motion to the head relative to whatever the stationary part of the apparatus is attached to (such as a deer body, e.g.). In such a case, the animal head (again, e.g., the head) might be deemed the decoy, even though it may be part of a full animal body decoy.

In at least one embodiment, the separately commercially available animal decoy is a sold separately from the animal decoy moving apparatus, as where the animal decoy is available to consumers as an entirely distinct product that may be manufactured by another entity. The separately commercially available animal decoy may be a conventional stationary decoy, referring to its “traditional” use (note that such reference certainly does not preclude the use of the stationary decoy as part of a moving decoy system). An animal decoy may be considered “separately commercially available” even where the decoy is also sold as part of a “kit” that also includes the decoy moving device—as long as the decoy is available for purchase by consumers separately from the decoy moving apparatus product (regardless of whether it is also available as part of a kit that includes the decoy moving apparatus disclosed herein), then the decoy may be considered a separately commercially available animal decoy. Indeed, in at least one other embodiment, the separately commercially available animal decoy is sold along with (and perhaps as part of) the decoy moving apparatus.

In at least one embodiment, the electrical wind independent turntable motion provision element rotationally oscillates the turntable along an advance sweep (25) and a reverse sweep (26) during operation of the animal decoy moving apparatus. The wind independent turntable motion provision element may rotate the turntable along one of the sweeps (e.g., the reverse sweep) faster that it rotates the turntable along the other sweep. This differential speed capability may be achieved by, e.g., a camming device to which the turntable is responsive, and may further enhance the life-like appearance of the moving decoy. In a preferred embodiment, the sweep is less than 90 degrees, but other arc sizes are contemplated by the inventors.

Importantly, in at least one embodiment of the invention, the animal decoy moving apparatus is animal inspecific, as it is usable with decoys of more than one kind of animal (e.g., goose, duck, turkey and rabbit, as but a few examples); similarly, the gamebird decoy moving apparatus aspect of the invention is gamebird inspecific, as it is usable with decoys of more than one kind of gamebird (goose and duck, e.g.). Additionally, in at least one embodiment, the separately commercially available animal decoy requires no alteration in order to be moved by the animal decoy moving apparatus. In at least one other embodiment, however, the some kinds of separately commercially available animal decoys may require some degree of alteration (typically slight), such as merely establishing a small hole in an appropriate spot on, e.g., a shell decoy, in order to attach the animal decoy attachment adapter.

In at least one embodiment of the invention, the separately commercially available animal decoy may be a full body decoy or a shell decoy (indeed, the decoy moving apparatus may be considered to be decoy design type inspecific). In terms of specific models of decoy, and in at least one embodiment of the invention, the separately commercially available animal decoy or conventional stationary animal decoy may be a BigFoot, Higdon, Flambeau, Carry-Lite, Hard Core Full Body, GNH, or Avery decoy, as but a few examples.

In at least one embodiment of the invention, the turntable comprises a column (9) having a base at the lower portion of the turntable. The column itself may comprise or house an electric motor (8) that makes up part of the wind independent turntable motion provision element. In at least one embodiment of the invention, the column may comprise at least a part of the animal decoy attachment element. For example, where the separately commercially available animal decoy has a space between the animal decoy feet (i.e., the separately commercially available animal decoy is not “solid footed”), the column may be sized or adapted for establishment in that space. The column may have a non-circular cross-section to facilitate attachment of the decoy to the turntable, e.g., thereby improving impartation of motion of the turntable to the decoy by enhancing the attachment. Indeed, in at least one embodiment of the invention, a column, perhaps having a non-circular cross-section, may be the animal decoy attachment element.

In at least one embodiment of the invention, the wind independent turntable motion provision element (which, as stated earlier, may be electrical) may comprise a battery pack (27) and/or a remote control devise(s) (28) and/or a turntable speed control device and/or a timer switch enabling delayed functioning of the apparatus. Of course, the remote control device would enable control of the decoy from, e.g., a blind or pit.

In at least one embodiment of the invention, the market condition of the separately commercially available animal decoy does not reflect any adaptation that is specifically intended to facilitate use of the separately commercially available waterfowl decoy uniquely with the animal decoy moving apparatus. For example, a separately commercially available decoy such as a shell decoy might have a small hole that might be intended to facilitate use of the decoy with a supporting post, but such an adaptation is not specifically intended to facilitate use of the shell decoy uniquely with the inventive decoy moving apparatus disclosed herein. Such a characterization (i.e., the absence of any adaptation that is specifically intended to facilitate use of the separately commercially available waterfowl decoy uniquely with the animal decoy moving apparatus) may serve to further distinguish the inventive technology disclosed herein from those prior art decoy movers that are usable only with a decoy that reflects certain design feature(s) enabling its use with the decoy mover. Such decoy movers are thus not usable with the commercially available “conventional” decoys, either as sold or with only slight modification. Indeed, such is a marked disadvantage of some existing technologies—a hunter, e.g., who wants controlled decoy moving capability may be forced to purchase not only a decoy mover, but also that decoy that itself is specifically adapted for use uniquely with that decoy mover. This hunter would be unable to realize the savings afforded by the present invention's compatibility with decoys that the hunter might already own (with perhaps only slight alteration with some decoys). Such is a significant advantage of at least one embodiment of the invention herein disclosed—the provision of a decoy moving apparatus that is usable to controllably move commercially available animal decoys (again, perhaps with some slight modification), and thus that is usable with animal decoys that might already be owned by a hunter. Another related advantage is apparent in the case of a first time hunter, e.g., who prefers both stationary and moving decoy capability. If such a hunter requires for his or her needs, ten decoys at any one time (whether they all be moving, stationary, or a mix of both), such a hunter need not purchase ten of the decoys that are uniquely and specifically designed for use with the decoy movers, each of which is expectedly significantly more expensive than the conventional decoys (e.g., the separately commercially available decoys that do not reflect any adaptation specifically intended to facilitate use uniquely with the decoy moving apparatus disclosed herein). The inventive technology disclosed herein allows that hunter to purchase 10 of the less expensive conventional decoys, which or course are usable in a stationary mode, but also usable (perhaps with slight alteration for use with some decoys) with the decoy moving apparatus disclosed herein.

Additionally, conventional, controlled motion decoy moving systems that may be usable to controllably move more than one type of decoy (e.g., at least three types, where the types may be shell, full-body and post), can do so only after substantive modification of the decoy. As mentioned, such substantive modification is undesired because it may compromise the decoys effectiveness, and involve time and effort by the moving decoy system user, as but two reasons.

At least one embodiment of the invention may comprise a moving decoy part (e.g., a turntable) that is a battery powered and motor driven to move decoys. The moving decoy part can be used to add motion for hunting and even display applications, contributing a degree of animation and realism to the application. The decoys that are used with the moving decoy part may be constructed out of plastic, cork, wood or other materials and resemble bird or animal species such as geese, ducks, turkeys, and rabbits, as but a few animals. Such a decoy may be attached to the moving decoy part using the part's grabbers and/or straps. When the power is turned on, the moving decoy part may rotate and/or reverse, on a plane from perhaps 5 to 360 degrees, at a speed and interval controlled by the operator using hard switches and/or remote control switches. The moving decoy part may be designed for weatherproof, outdoor applications under variable temperatures. It may be constructed around an electric motor assembly attached to a metal bearing turntable, which itself may be attached to exterior pieces. The outside diameter of an assembled moving decoy part that is circular in shape may be approximately 9.5 inches. In addition to the moving decoy part assembly, the battery power supply and circuitry may be located in a small weatherproof box (e.g., plastic), that may connect to the moving decoy part using a cable that may be approximately 24 inches. An adaptor to provide a flat surface to the moving decoy part may also be available and included with the moving decoy part. Parts of the device may be produced in various colors including but not limited to black, brown, gray or camouflage.

It is important to understand that this disclosure is intended to include a decoy moving apparatus that is more limited that an animal decoy moving apparatus. Specifically, this disclosure should be understood to encompass, as but a few examples, a waterfowl decoy moving apparatus, a gamebird decoy moving apparatus, a shell decoy moving apparatus, full-body decoy moving apparatus, and a predator decoy moving apparatus, as but a few examples.

Note that as used in the claims, “respond” and variant forms thereof, takes on its ordinary definition of react; when a first element is “responsive to” a second element, then a stimulus in the second element causes a reaction in the first element. Associative use of the term “responsive to” (or variant forms such as “responds to” or “to which ______ is responsive”, as but only two other examples) usually, but not always, implies some type of structural connection, engagement, or coupling, however indirect (and even if releasable), between the elements associated.

As can be easily understood from the foregoing, the basic concepts of the present invention may be embodied in a variety of ways. It involves both decoy moving techniques as well as devices to accomplish the appropriate decoy movement. In this application, the decoy moving techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may focus on the device described, but also method or process claims may be address the functions the invention and each element performs. Neither the description nor the terminology is intended to limit the scope of the claims.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. The reader should be aware that this disclosure is to be understood to support as broad a part of claims as deemed within the applicant's right and is designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding, this last aspect, as but one example, the disclosure of an “adapter” should be understood to encompass disclosure of the act of “adapting”—whether explicitly discussed or not—and, conversely, were there effectively disclosure of the act of “adapting”, such a disclosure should be understood to encompass disclosure of an “adapter” and even a “means for adapting” Such changes and alternative terms are to be understood to be explicitly included in the description.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the decoy moving devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or, group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A gamebird decoy moving apparatus comprising:
a base element;
a turntable responsive to said base element and configured to support a gamebird decoy that is commercially available separately from said gamebird decoy moving apparatus;
an electrical, wind independent turntable motion provision element to which said turntable is rotationally responsive; and
a gamebird decoy attachment element usable to attach said separately commercially available gamebird decoy to said turntable,
wherein said electrical, wind independent turntable motion provision element rotationally oscillates said turntable along an advance sweep and a reverse sweep during operation of said gamebird decoy moving apparatus,
wherein said gamebird decoy moving apparatus is usable to impart motion to decoys of different kinds of gamebird at different times, and
wherein said gamebird decoy moving apparatus is usable to move each of at least three different types of said separately commercially available gamebird decoys at different times without requiring substantive modification of any of each of said at least three different types of said separately commercially available gamebird decoys.

2. A gamebird decoy moving apparatus as described in claim 1 not comprising said separately commercially available gamebird decoy.

3. A gamebird decoy moving apparatus as described in claim 1 wherein said electrical, wind independent turntable motion provision element comprises an electric motor that is established substantially in a column whose base is attached substantially at a centroid of a lower portion of said turntable.

4. A gamebird decoy moving apparatus as described in claim 1 wherein said turntable comprises a substantially disc shaped turntable

5. A gamebird decoy moving apparatus as described in claim 1 wherein said separately commercially available gamebird decoy is selected from the group consisting of: duck decoy; turkey decoy; goose decoy.

6. A gamebird decoy moving apparatus as described in claim 1 wherein said gamebird decoy attachment element comprises at least one Velcro® strap.

7. A gamebird decoy moving apparatus as described in claim 1 wherein said gamebird decoy attachment element comprises a gamebird decoy attachment adapter.

8. A gamebird decoy moving apparatus as described in claim 7 wherein said gamebird decoy attachment adapter comprises a solid foot decoy adapter.

9. A gamebird decoy moving apparatus as described in claim 8 wherein said solid foot decoy comprises a Flambeau decoy.

10. A gamebird decoy moving apparatus as described in claim 8 wherein said solid foot decoy adapter is usable to establish a flat upper turntable surface

11. A gamebird decoy moving apparatus as described in claim 10 wherein said turntable further comprises a vertical column with a base on a lower portion of said turntable.

12. A gamebird decoy moving apparatus as described in claim 8 wherein said solid foot decoy adapter further comprises a Velcro® strap.

13. A gamebird decoy moving apparatus as described in claim 7 wherein said gamebird decoy attachment adapter comprises at least one support stake, full body gamebird decoy adapter usable with a full body gamebird decoy having at least one support stake.

14. A gamebird decoy moving apparatus as described in claim 13 wherein said at least one support stake, full body gamebird decoy adapter comprises a stake support element responsive to said turntable.

15. A gamebird decoy moving apparatus as described in claim 14 wherein said turntable comprises a vertical column with a base on a lower portion of said turntable and said stake support element comprises a column surrounding section.

16. A gamebird decoy moving apparatus as described in claim 14 further comprising a decoy stake supported by said stake support element.

17. A gamebird decoy moving apparatus as described in claim 14 further comprising an elastic cord attachment element to which said stake support element is responsive.

18. A gamebird decoy moving apparatus as described in claim 7 wherein said gamebird decoy attachment adapter comprises a shell gamebird decoy adapter.

19. A gamebird decoy moving apparatus as described in claim 18 wherein said shell gamebird decoy adapter comprises at least one decoy post responsive to said turntable and configured for attachment inside of a shell gamebird decoy.

20. A gamebird decoy moving apparatus as described in claim 19 wherein said at least one decoy post comprises two posts.

21. A gamebird decoy moving apparatus as described in claim 19 wherein said shell gamebird decoy adapter comprises a decoy post support element.

22. A gamebird decoy moving apparatus as described in claim 21 wherein said turntable comprises a column having its base on a lower portion of said turntable and said decoy post support element comprises a column surrounding section.

23. A gamebird decoy moving apparatus as described in claim 22 wherein said column surrounding section has a larger lower radius than upper radius for tight fit.

24. A gamebird decoy moving apparatus as described in claim 7 wherein said gamebird decoy attachment adapter comprises a post supported decoy adapter.

25. A gamebird decoy moving apparatus as described in claim 24 wherein said post supported decoy adapter comprises a turntable motion impartation element that is responsive to said turntable and that is usable to impart motion of said turntable to a post supported decoy.

26. A gamebird decoy moving apparatus as described in claim 25 wherein said turntable motion impartation element comprises at least one post supported decoy post reception element.

27. A gamebird decoy moving apparatus as described in claim 26 wherein said at least one post supported decoy post reception element comprises a post supported decoy post retention element.

28. A gamebird decoy moving apparatus as described in claim 26 wherein said at least one post supported decoy post reception element comprises two post supported decoy post reception elements.

29. A gamebird decoy moving apparatus as described in claim 26 wherein a column forms a part of said turntable and wherein said turntable motion impartation element further comprises a column surrounding section to which said at least one post supported decoy post reception elements is responsive.

30. A gamebird decoy moving apparatus as described in claim 24 wherein said post supported decoy adapter is a turkey decoy adapter.

31. A gamebird decoy moving apparatus as described in claim 1 wherein said separately commercially available gamebird decoy is sold separately from said gamebird decoy moving apparatus.

32. A gamebird decoy moving apparatus as described in claim 1 wherein said electrical, wind independent turntable motion provision element rotates said turntable along one of said sweeps faster that it rotates said turntable along the other sweep.

33. A gamebird decoy moving apparatus as described in claim 32 wherein said gamebird decoy moving apparatus further comprises a camming device to which said turntable is responsive.

34. A gamebird decoy moving apparatus as described in claim 1 wherein said sweep is less than 90 degrees.

35. A gamebird decoy moving apparatus as described in claim 1 wherein said gamebird decoy moving apparatus is gamebird inspecific.

36. A gamebird decoy moving apparatus as described in claim 1 wherein said separately commercially available gamebird decoy requires no modification in order to be moved by said gamebird decoy moving apparatus.

37. A gamebird decoy moving apparatus as described in claim 1 wherein different kinds of gamebird comprises goose, duck and turkey.

38. A gamebird decoy moving apparatus as described in claim 1 wherein said separately commercially available gamebird decoy is a gamebird decoy selected from the group consisting of: full body decoys and shell decoys.

39. A gamebird decoy moving apparatus as described in claim 1 wherein said separately commercially available gamebird decoy comprises a decoy selected from the group consisting of: BigFoot, Higdon, Flambeau, Carry-Lite, Hard Core Full Body, GNH, and Avery.

40. A gamebird decoy moving apparatus as described in claim 1 wherein said turntable further comprises a column having a base on a lower portion of said turntable.

41. A gamebird decoy moving apparatus as described in claim 40 wherein said column comprises an electric motor that makes up part of said electrical, wind independent turntable motion provision element.

42. A gamebird decoy moving apparatus as described in claim 40 wherein said column comprises at least a part of said gamebird decoy attachment element.

43. A gamebird decoy moving apparatus as described in claim 42 wherein said separately commercially available gamebird decoy has a space between gamebird decoy feet and wherein said column is adapted for establishment in said space.

44. A gamebird decoy moving apparatus as described in claim 43 wherein said column has a non-circular cross-section.

45. A gamebird decoy moving apparatus as described in claim 1 wherein said electrical, wind independent turntable motion provision element comprises battery pack.

46. A gamebird decoy moving apparatus as described in claim 1 wherein said electrical, wind independent turntable motion provision element comprises a remote control device.

47. A gamebird decoy moving apparatus as described in claim 1 wherein said electrical, wind independent turntable motion provision element comprises turntable speed control device.

48. A gamebird decoy moving apparatus as described in claim 1 wherein said electrical, wind independent turntable motion provision element comprises a timer switch enabling delayed functioning.

49. A gamebird decoy moving apparatus as described in claim 1 further comprising said separately commercially available gamebird decoy.

50. A gamebird decoy moving apparatus as described in claim 1 wherein the market condition of said separately commercially available gamebird decoy does not reflect any adaptation that is specifically intended to facilitate use of said separately commercially available gamebird decoy uniquely with said gamebird decoy moving apparatus.

51. A gamebird decoy moving apparatus as described in claim 1 wherein said at least three different types of separately commercially available gamebird decoys comprise shell decoys, post supported decoys, and free-standing, full body decoys.

52. An animal decoy moving apparatus comprising:
a base element;
a turntable responsive to said base element and configured to support an animal decoy that is commercially available separately from said animal decoy moving apparatus;
a wind independent turntable motion provision element to which said turntable is responsive; and
an animal decoy attachment element usable to attach said separately commercially available animal decoy to said turntable, and
wherein said animal decoy moving apparatus is usable to impart motion to decoys of different kinds of animals at different times.

53. An animal decoy moving apparatus as described in claim 52 wherein said animal decoy moving apparatus is usable to impart motion to both shell animal decoys and full-body animal decoys at different times.

54. An animal decoy moving apparatus as described in claim 52 wherein said separately commercially available animal decoy comprises an animal decoy selected from the group consisting of: duck decoy, goose decoy, turkey decoy.

55. An animal decoy moving apparatus as described in claim 52 wherein said separately commercially available animal decoy comprises an animal decoy selected from the group consisting of: deer decoy and elk decoy.

56. An animal decoy moving apparatus as described in claim 52 wherein said separately commercially available animal decoy comprises an animal decoy selected from the group consisting of: rabbit decoy, bird decoy, fawn decoy.

57. An animal decoy moving apparatus as described in claim 52 wherein said separately commercially available animal decoy comprises an animal decoy selected from the group consisting of: furred animal decoy and feathered animal decoy.

58. An animal decoy moving apparatus as described in claim 52 wherein said animal decoy moving apparatus comprises an electrical animal decoy moving apparatus.

59. An animal decoy moving apparatus as described in claim 52 wherein said turntable is rotationally responsive to said wind independent turntable motion provision element.

60. An animal decoy moving apparatus as described in claim 52 wherein said wind independent turntable motion provision element comprises an electrical, wind independent, turntable motion provision element.

61. An animal decoy moving apparatus as described in claim 60 wherein said electrical, wind independent turntable motion provision element comprises a motor that is established substantially in a column whose base is attached substantially at a centroid of a lower portion of said turntable.

62. An animal decoy moving apparatus as described in claim 52 not comprising said separately commercially available animal decoy.

63. An animal decoy moving apparatus as described in claim 52 wherein said turntable comprises a substantially disc shaped turntable.

64. An animal decoy moving apparatus as described in claim 52 wherein said animal decoy attachment element comprises at least one Velcro® strap.

65. An animal decoy moving apparatus as described in claim 52 wherein said animal decoy attachment element comprises a animal decoy attachment adapter.

66. An animal decoy moving apparatus as described in claim 65 wherein said animal decoy attachment adapter comprises a solid foot decoy adapter.

67. An animal decoy moving apparatus as described in claim 66 wherein said solid foot decoy comprises a Flambeau decoy

68. An animal decoy moving apparatus as described in claim 66 wherein said solid foot decoy adapter is usable to establish a flat upper turntable surface.

69. An animal decoy moving apparatus as described in claim 68 wherein said turntable comprises a column having its base on a lower portion of said turntable.

70. An animal decoy moving apparatus as described in claim 66 wherein said solid foot decoy adapter further comprises a Velcro® strap.

71. An animal decoy moving apparatus as described in claim 65 wherein said animal decoy attachment adapter comprises at least one support stake, full body animal decoy adapter usable with a full body animal decoy having at least one support stake.

72. An animal decoy moving apparatus as described in claim 71 wherein said at least one support stake, full body animal decoy adapter comprises a stake support element responsive to said turntable.

73. An animal decoy moving apparatus as described in claim 72 wherein said turntable comprises a column having its base on a lower portion of said turntable and said stake support element comprises a column surrounding section.

74. An animal decoy moving apparatus as described in claim 72 further comprising a decoy stake supported by said stake support element.

75. An animal decoy moving apparatus as described in claim 72 further comprising an elastic cord attachment element to which said stake support element is responsive.

76. An animal decoy moving apparatus as described in claim 65 wherein said animal decoy attachment adapter comprises a shell animal decoy adapter.

77. An animal decoy moving apparatus as described in claim 76 wherein said shell animal decoy adapter comprises at least one decoy post responsive to said turntable and configured for attachment inside of a shell animal decoy.

78. An animal decoy moving apparatus as described in claim 77 wherein said at least one decoy post comprises two posts.

79. An animal decoy moving apparatus as described in claim 77 wherein said shell animal decoy adapter comprises a decoy post support element.

80. An animal decoy moving apparatus as described in claim 79 wherein said turntable comprises a column having a base on a lower portion of said turntable and said decoy post support element comprises a column surrounding section.

81. An animal decoy moving apparatus as described in claim 80 wherein said column surrounding section has a larger lower radius than upper radius for tight fit.

82. An animal decoy moving apparatus as described in claim 65 wherein said animal decoy attachment adapter comprises a post supported decoy adapter.

83. An animal decoy moving apparatus as described in claim 82 wherein said post supported decoy adapter comprises a turntable motion impartation element that is responsive to said turntable and that is usable to impart motion of said turntable to a post supported decoy.

84. An animal decoy moving apparatus as described in claim 83 wherein said turntable motion impartation element comprises at least one post supported decoy post reception element.

85. An animal decoy moving apparatus as described in claim 84 wherein said at least one post supported decoy post reception element comprises a post supported decoy post retention element.

86. An animal decoy moving apparatus as described in claim 84 wherein said at least one post supported decoy post reception element comprises two post supported decoy post reception elements.

87. An animal decoy moving apparatus as described in claim 84 wherein said turntable comprises a column having its base on a lower portion of said turntable and wherein said turntable motion impartation element further comprises a column surrounding section to which said at least one post supported decoy post reception elements is responsive.

88. An animal decoy moving apparatus as described in claim 82 wherein said post supported decoy adapter comprises a turkey decoy adapter.

89. An animal decoy moving apparatus as described in claim 52 wherein separately commercially available animal decoy is sold separately from said turntable.

90. An animal decoy moving apparatus as described in claim 52 wherein said wind independent turntable motion provision element rotationally oscillates said turntable along an advance sweep and a reverse sweep during operation of said animal decoy moving apparatus.

91. An animal decoy moving apparatus as described in claim 90 wherein said wind independent turntable motion provision element rotates said turntable along one of said sweeps faster that it rotates said turntable along the other sweep.

92 An animal decoy moving apparatus as described in claim 91 wherein said animal decoy moving apparatus further comprises a camming device to which said turntable is responsive.

93. An animal decoy moving apparatus as described in claim 90 wherein said sweep is less than 90 degrees.

94. An animal decoy moving apparatus as described in claim 52 wherein said animal decoy moving apparatus is animal inspecific.

95. An animal decoy moving apparatus as described in claim 52 wherein said separately commercially available animal decoy requires no modification in order to be moved by said animal decoy moving apparatus.

96. An animal decoy moving apparatus as described in claim 95 wherein said separately commercially available animal decoy requires no substantive modification in order to be moved by said animal decoy moving apparatus.

97. An animal decoy moving apparatus as described in claim 52 wherein different kinds of animal comprises goose, duck, turkey.

98. An animal decoy moving apparatus as described in claim 52 wherein different kinds of animal comprises rabbit, bird, fawn.

99. An animal decoy moving apparatus as described in claim 52 wherein different kinds of animal comprises furred animal and feathered animal.

100. An animal decoy moving apparatus as described in claim 52 wherein different kinds of animal comprises deer and elk.

101. An animal decoy moving apparatus as described in claim 52 wherein said separately commercially available animal decoy is a animal decoy selected from the group consisting of full body decoys and shell decoys.

102. An animal decoy moving apparatus as described in claim 52 wherein said separately commercially available animal decoy comprises a decoy selected from the group consisting of: BigFoot, Higdon, Flambeau, Carry-Lite, Hard Core Full Body, GNH, and Avery.

103. An animal decoy moving apparatus as described in claim 52 wherein said turntable further comprises a column having a base on a lower portion of said turntable.

104. An animal decoy moving apparatus as described in claim 103 wherein said column comprises electric motor that makes up part of wind independent turntable motion provision element.

105. An animal decoy moving apparatus as described in claim 103 wherein said column comprises at least a part of said animal decoy attachment element.

106. An animal decoy moving apparatus as described in claim 105 wherein said separately commercially available animal decoy has a space between animal decoy feet and wherein said column is adapted for establishment in said space.

107. An animal decoy moving apparatus as described in claim 106 wherein said column has a non-circular cross-section.

108. An animal decoy moving apparatus as described in claim 52 wherein wind independent turntable motion provision element comprises battery pack.

109. An animal decoy moving apparatus as described in claim 52 wherein wind independent turntable motion provision element comprises remote control device.

110. An animal decoy moving apparatus as described in claim 52 wherein wind independent turntable motion provision element comprises turntable speed control device.

111. An animal decoy moving apparatus as described in claim 52 wherein wind independent turntable motion provision element comprises timer switch enabling delayed functioning.

112. An animal decoy moving apparatus as described in claim 52 further comprising said separately commercially available animal decoy.

113. An animal decoy moving apparatus as described in claim 52 wherein the market condition of said separately commercially available animal decoy does not reflect any adaptation that is specifically intended to facilitate use of said separately commercially available animal decoy uniquely with said turntable.

114. An animal decoy moving apparatus as described in claim 52 wherein said animal decoy moving apparatus is usable to move each of at least three different types of said separately commercially available animal decoys at different times without requiring substantive modification of any of each of said at least three different types of separately commercially available animal decoys.

115. An animal decoy moving apparatus as described in claim 114 wherein said at least three different types of said separately commercially available animal decoys comprises shell decoys, post-supported decoys, and free-standing, fully body decoys.

116. A gamebird decoy moving method comprising:
providing a base element;
establishing a turntable responsive to said base element;
configuring said turntable to support a gamebird decoy that is commercially available separately from said turntable;
establishing an electrical, wind independent turntable motion provision element to which said turntable is rotationally responsive; and
providing a gamebird decoy attachment element usable to attach said separately commercially available gamebird decoy to said turntable,
wherein said electrical, wind independent turntable motion provision element rotationally oscillates said turntable along an advance sweep and a reverse sweep,
wherein said game bird decoy moving method is usable to impart motion to decoys of different kinds of gamebird at different times, and
wherein said gamebird decoy moving method is usable to move each of at least three different types of said separately commercially available gamebird decoys at different times without requiring substantive modification of any of each of said at least three different types of said separately commercially available gamebird decoys.

117. A gamebird decoy moving method as described in claim 116 wherein said gamebird decoy attachment element comprises a gamebird decoy attachment adapter selected from the group consisting of: solid foot decoy adapter, post supported decoy and shell decoy

118. A gamebird decoy moving method as described in claim 116 wherein said electrical, wind independent turntable motion provision element rotates said turntable along one of said sweeps faster that it rotates said turntable along the other sweep

119. A gamebird decoy moving method as described in claim 116 wherein said separately commercially available gamebird decoy requires no modification in order to be moved according to said gamebird decoy moving method.

120. A gamebird decoy moving method as described in claim 116 wherein different kinds of gamebird comprises goose, duck and turkey.

121. A gamebird decoy moving method as described in claim 116 wherein said separately commercially available gamebird decoy is a gamebird decoy selected from the group of gamebird decoys consisting of: full body decoys and shell decoys.

122. A gamebird decoy moving method as described in claim 116 wherein said separately commercially available gamebird decoy comprises a decoy selected from the group of commercially available gamebird decoys consisting of: BigFoot, Higdon, Flambeau, CarryLite, Hard Core Full Body, GNH, and Avery.

123. A gamebird decoy moving method as described in claim 116 wherein electrical, wind independent turntable motion provision element comprises battery pack.

124. A gamebird decoy moving method as described in claim 116 wherein electrical, wind independent turntable motion provision element comprises remote control device.

125. A gamebird decoy moving method as described in claim 116 wherein electrical, wind independent turntable motion provision element comprises turntable speed control device.

126. A gamebird decoy moving method as described in claim 116 wherein electrical, wind independent turntable motion provision element comprises timer switch enabling delayed functioning.

127. A gamebird decoy moving method as described in claim 116 fc the step of providing said separately commercially available gamebird decoy.

128. A gamebird decoy moving method as described in claim 116 wherein said at least three different types of separately commercially available gamebird decoys comprises shell decoys, post-supported decoys, and free-standing, fully body decoys.

129. An animal decoy moving method comprising:
providing a base element;
establishing a turntable responsive to said base element;
configuring said turntable to support an animal decoy that is commercially available separately from said turntable;
establishing a wind independent turntable motion provision element so that said turntable is responsive to said wind independent turntable motion provision element, and
providing an animal decoy attachment element usable to attach said separately commercially available animal decoy to said turntable,
wherein said animal decoy moving method is usable to impart motion to both shell animal decoys and full-body animal decoys at different times.

130. An animal decoy moving method as described in claim 129 wherein said animal decoy moving method is usable to impart motion to decoys of different kinds of animals at different times.

131. An animal decoy moving method as described in claim 130 wherein said different kinds of animal comprises goose, duck, turkey.

132. An animal decoy moving method as described in claim 130 wherein said different kinds of animal comprises bird, fawn and rabbit.

133. An animal decoy moving method as described in claim 130 wherein said different kinds of animal comprises deer and elk.

134. An animal decoy moving method as described in claim 130 wherein said different kinds of animal comprises furred animal and feathered animal.

135. An animal decoy moving method as described in claim 129 wherein said turntable is rotationally responsive to said wind independent turntable motion provision element.

136. An animal decoy moving method as described in claim 129 wherein said separately commercially available animal decoy comprises an animal decoy selected from the group of animal decoys consisting of: rabbit decoy, bird decoy, fawn decoy.

137. An animal decoy moving method as described in claim 129 wherein said separately commercially available animal decoy comprises an animal decoy selected from the group of animal decoys consisting of: furred animal decoy and feathered animal decoy.

138. An animal decoy moving method as described in claim 129 wherein said animal decoy attachment element comprises at least one Velcro® strap.

139. An animal decoy moving method as described in claim wherein said animal decoy attachment element comprises a animal decoy attachment adapter selected from the group consisting of solid foot decoy adapter, post supported decoy adapter, and shell decoy adapter.

140. An animal decoy moving method as described in claim 129 wherein said wind independent turntable motion provision element rotationally oscillates said turntable along an advance sweep and a reverse sweep

141. An animal decoy moving method as described in claim 129 wherein said separately commercially available animal decoy requires no modification in order to be moved according said animal decoy moving method.

142. An animal decoy moving method as described in claim 141 wherein said separately commercially available animal decoy requires no substantive modification in order to be moved according to said animal decoy moving method.

143. An animal decoy moving method as described in claim 129 wherein said separately commercially available animal decoy comprises a decoy selected from the group of commercially available decoys consisting of: BigFoot, Higdon, Flambeau, Carry-Lite, Hard Core Full Body, GNH, and Avery.

144. An animal decoy moving method as described in claim 129 wherein said animal decoy moving method is usable to attach and move each of at least three different types of separately commercially available animal decoys at different times without requiring substantive modification of any of each of said at least three different types of separately commercially available animal decoys.

145. An animal decoy moving method as described in claim 144 wherein said at least three different types of separately commercially available animal decoys comprise shell decoys, post supported decoys, and free-standing, fully body decoys.

146. An animal decoy moving method comprising the steps of:
placing a turntable responsive to a base element on a surface;
attaching a conventional, stationary animal decoy to said turntable without modifying said animal decoy and through use of an animal decoy attachment element,
activating a wind independent, turntable motion provision element to which said turntable is rotationally responsive;
controllably rotating said turntable and said animal decoy attached to said turntable,
wherein said animal decoy moving method is usable to move a shell decoy; a free-standing, full body decoy, and a post supported decoy, at different times, without requiring modification of said conventional, stationary animal decoys.

147. An animal decoy moving method as described in claim 146 wherein the step of attaching a conventional, stationary animal decoy to said turntable without modifying said animal decoy comprises the step of attaching an animal decoy to said turntable without substantively modifying said animal decoy.

148. An animal decoy moving apparatus comprising:
a base element;
a turntable responsive to said base element and configured to support conventional, stationary animal decoy that is commercially available separately from said animal decoy moving apparatus;
an electrical, wind independent turntable motion provision element to which said turntable is rotationally responsive; and
an animal decoy attachment element usable to attach said conventional stationary animal decoy to said turntable,
wherein said animal decoy moving apparatus is usable to impart motion to decoys of different kinds of animals at different times, and
wherein said animal decoy moving apparatus is usable to move a free-standing, full body decoy without requiring substantive modification of said free-standing, full body decoy.

149. An animal decoy moving apparatus as described in claim 148 wherein said animal decoy moving apparatus is usable to move a free-standing, full body decoy without requiring removal of the foot assembly of said free-standing, full body decoy.
